(19) United States
(12) Patent Application Publication
(10) Pub. No.: US 2006/0165072 A1
(43) Pub. Date: Jul. 27, 2006

(54) Device comprising an array of microsystems which can be individually addressed by means of electromagnetic transmission, and method of addressing one such device

(75) Inventors: Francois Vacherand, Pont de Claix (FR); Elisabeth Crochon, Poisat (FR)

Correspondence Address: OLIFF & BERRIDGE, PLC, P.O. BOX 19928, ALEXANDRIA, VA, 22320, US

(73) Assignee: Commissariat A L'Energie Atomique, Paris (FR)

(21) Appl. No.: 10/563,491

(22) PCT Filed: Jul. 8, 2004
(86) PCT No.: PCT/FR04/01806

§ 371 Date: Jan. 5, 2006

(30) Foreign Application Priority Data
Jul. 10, 2003 (FR) 03/08463

(51) Int. Cl. H04L 12/56

(52) U.S. Cl. 370/389; 340/825.52; 340/870.03; 340/10.1

(57) ABSTRACT

The microsystems communicate by electromagnetic transmission, preferably by radio frequency, with a control circuit. An initialization phase of the method of addressing successively comprises addressing, by the control circuit, of each microsystem by an identification code that is proper to the latter and storing, in a register of the microsystem, of a reduced addressing code supplied by the control circuit. A subsequent addressing phase comprises transmission to all the microsystems, by the control circuit, of reset signals and increment signals. Each microsystem monitors resetting of at least one counter upon receipt of a reset signal and incrementation of the content of the counter upon receipt of an increment signal. Each microsystem compares the contents of its counter and of its register so as to trigger execution of a pre-determined command when these contents are identical.

### BACKGROUND OF THE INVENTION

The invention relates to a device comprising an array of microsystems which can be individually addressed by a control circuit.

### STATE OF THE ART

An array of microsystems is generally connected by wiring to a control circuit typically comprising a multiplexer enabling each microsystem to be addressed individually. Addressing of a microsystem is followed by transfer of signals between the microsystem and the circuit and, in certain cases, also by transfer of electromagnetic power for supply of the microsystem. The following can be cited, for example: actuator networks, memories, keyboards, readouts, flat-panel displays, etc . . . .

The number of microsystems per array can however be large and the wiring is thus cumbersome and difficult to implement. The connecting wires form very large bundles, which limits the possibilities of movement of the array with respect to the control circuit.

### OBJECT OF THE INVENTION

It is an object of the invention to remedy these shortcomings and, in particular, to simplify these devices, while reducing the cost and size thereof.

According to the invention, this object is achieved by the fact that the control circuit of each microsystem comprises electromagnetic transmission means.

The microsystems can comprise elements chosen from the group of actuators, sensors and display means, and the electromagnetic transmission means can comprise radio frequency transmission and/or receipt means, advantageously comprising antennas.

According to a development of the invention, the control circuit comprising supply means connected to the transmission means of the control circuit to enable supply of the microsystems by means of their respective transmission means, each microsystem comprises energy recovery means connected to the corresponding transmission means, and, advantageously, completed by energy storage means.

According to another feature of the invention, each microsystem comprises at least one register, a counter and a read-only memory containing an identification code of the associated microsystem.

It is a further object of the invention to provide a method of addressing the microsystems of the device according to the invention, having an initialization phase successively comprising, for each microsystem, addressing by the control circuit of the microsystem by its identification code and storing in the microsystem register of a reduced addressing code supplied by the control circuit, each subsequent addressing phase of the microsystems comprising:

transmission, by the control circuit, of a reset signal,

transmission, by the control circuit, of successive increment signals, each microsystem monitoring resetting of its counter upon receipt of a reset signal and incrementation of the content of its counter upon receipt of an increment signal, comparing the contents of its counter and of its register so as to trigger execution of a pre-determined command when these contents are identical.

The reduced addressing code of a microsystem can be a function of its position in the array and the reduced addressing codes of the microsystems can correspond to increasing numbers starting from a first microsystem.

According to a particular embodiment, the microsystems are arranged in lines and columns, the reduced addressing code of each microsystem comprising a line number and a column number respectively stored in line and column registers of the microsystem, the contents of the line and column registers being respectively compared with the contents of the line and column counters of the microsystem.

According to a development of the invention, the control circuit successively transmits line increment signals and column increment signals, the line increment signals causing the content of the line counters to be incremented and the column increment signals causing the content of the column counters to be incremented and the line counters of all the microsystems to be reset.

According to a development of the invention, the microsystems are arranged in lines, in columns and according to height, the reduced addressing code comprising an additional number associated to the height, stored in an additional register associated to the height, each microsystem comprising an additional counter associated to the height, the content of the register associated to the height being compared with the content of the counter associated to the height.

The control circuit can transmit height increment signals causing the additional counters associated to the height to be incremented and the line and column counters of all the microsystems to be reset.

A microsystem can transmit an acquit signal after it has executed its command.

The control circuit can transmit data representative of the type of command to be executed by the microsystems in association with transmission of a reset signal or in association with transmission of an increment signal.

### BRIEF DESCRIPTION OF THE DRAWINGS

Other advantages and features will become more clearly apparent from the following description of particular embodiments of the invention given as non-restrictive examples only and represented in the accompanying drawings, in which:

FIG. 1 schematically illustrates a particular embodiment of a device according to the invention.

FIG. 2 schematically shows a microsystem of the device according to FIG. 1.

FIG. 3 illustrates a particular embodiment of an initialization phase of a method according to the invention.

FIG. 4 is a table representing a particular embodiment of the correspondence between reset and increment signals and the corresponding modifications of the content of the counters of the microsystems arranged in a three-dimensional array.

FIG. 5 shows a flowchart of a particular embodiment of an addressing phase of the method according to the invention.

### DESCRIPTION OF PARTICULAR EMBODIMENTS

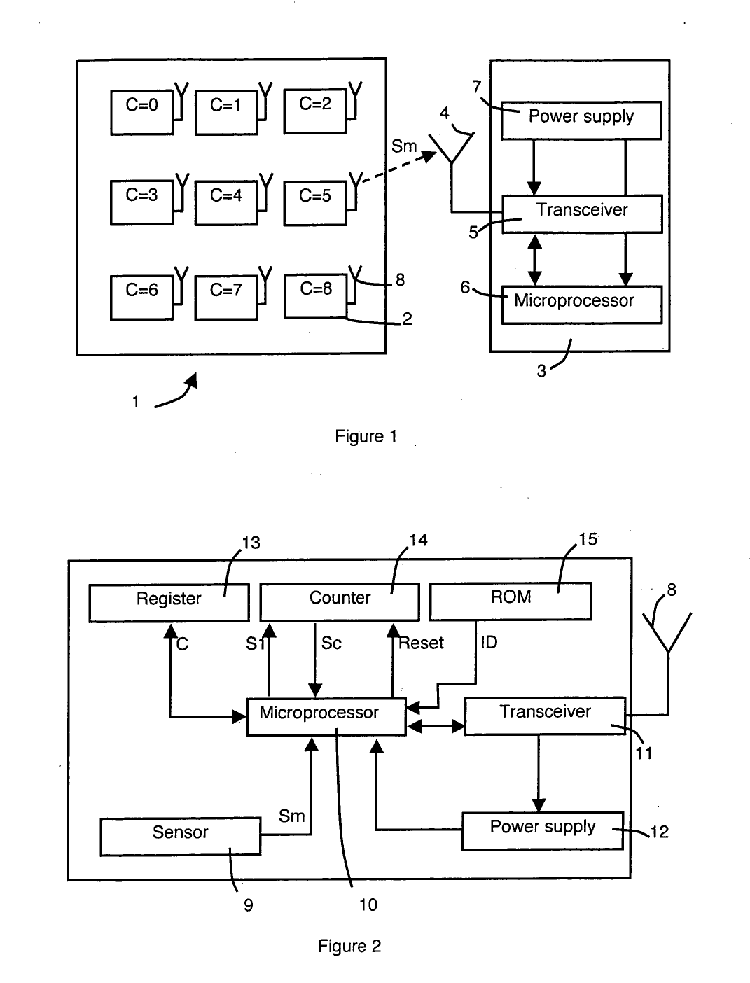

In FIG. 1, a device comprises an array 1 of microsystems 2, arranged in three lines and three columns, which can be individually addressed, without any contact, by a control circuit 3. The microsystems 2 comprise, for example, actuators, sensors and/or display elements. The control circuit 3 comprises an antenna 4, connected to a radio frequency transceiver 5 controlled by a processing circuit 6, for example a microprocessor-based circuit. The transceiver 5 and processing circuit 6 are connected to an electric power supply source 7. Each microsystem 2 comprises an antenna 8 enabling signals to be transmitted to the control circuit, for example signals Sm representative of measurements made by a microsystem 2, identified for example by a reduced addressing code C (C=0 to C=8 in FIG. 1).

In FIG. 2, the microsystem 2 comprises a sensor 9 transmitting measurement signals Sm to a processing circuit 10 of the microsystem 2, for example a microprocessor-based circuit. The measurement signals Sm can be transmitted to the control circuit 3 by means of a transceiver 11, connected to the processing circuit 10 and to the antenna 8 of the microsystem 2. The microsystem also comprises a power supply circuit 12 connected to the transceiver 11 and comprising an energy recovery circuit, for example a rectifier followed by a capacitor. Power supply of the microsystem 2 can thus be performed by transmission of electromagnetic power from the power supply source 7, by means of the respective transceivers 5 and 11 and antennas 4 and 8 of the control circuit 3 and of the microsystem 2. The power supply circuit 12 can in addition comprise energy storage means.

The processing circuit 10 of the microsystem 2 represented in FIG. 2 is also connected to a register 13 designed to contain the reduced addressing code C of the microsystem, to a counter 14 and to a read-only memory 15 (for example of ROM, EEPROM type . . . ) containing a unique identification code ID for each microsystem 2 and thus enabling individual addressing of the associated microsystem 2. The counter 14 comprises an increment input designed to receive increment signals S1, a reset input designed to receive a reset signal RAZ and an output enabling a signal Sc representative of the content of the counter 14 to be transmitted to the processing circuit 10.

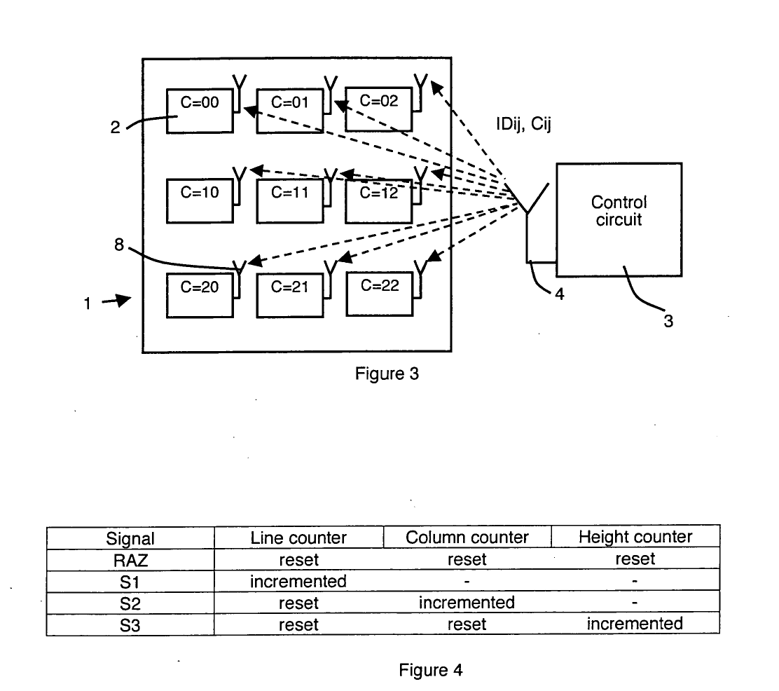

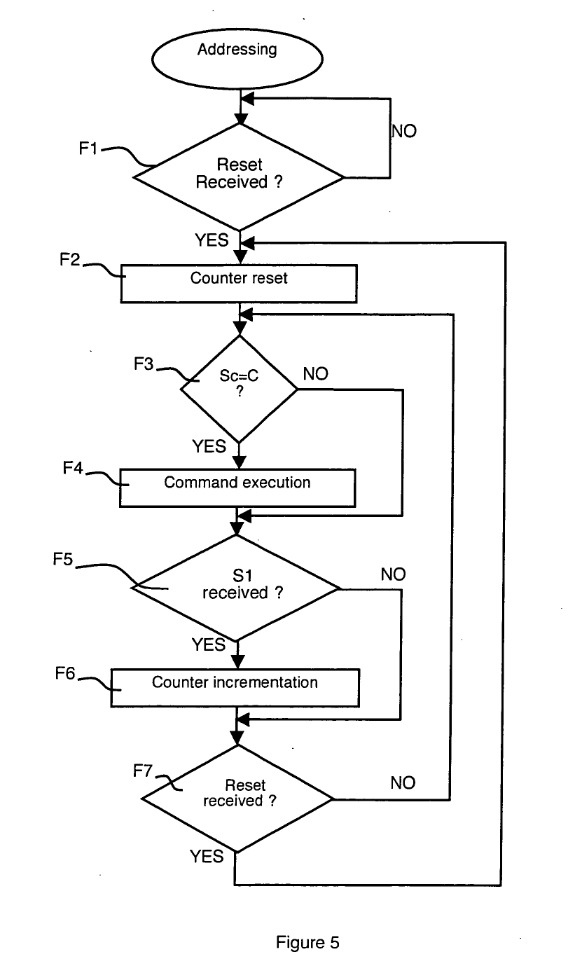

A method of addressing the microsystems 2 of a device according to the invention comprises an initialization phase (FIG. 3) and subsequent addressing phases (FIG. 5) of the microsystems 2. The initialization phase successively comprises, for each microsystem 2, addressing of the microsystem 2, by the control circuit 3, by its identification code ID and storing a reduced addressing code C, supplied by the control circuit 3, in the register 13 of the microsystem 2. Transcription of the identification codes ID to the reduced addressing codes C is bijective. Each microsystem 2 thus has a unique reduced addressing code C associated thereto, said code then enabling the microsystem 2 to be identified. The initialization phase can also enable the reduced addressing codes C to be reconfigured according to a different transcription table or in the case of replacement of a defective microsystem 2.

In FIG. 3, two radio frequency signals, respectively representative of an identification code IDij and of a reduced addressing code Cij, are transmitted by the control circuit 3, the indexes i and j being comprised between 0 and 2 and corresponding respectively to line i and column j of the array 1 of microsystems 2 represented in FIG. 3. Only the microsystem 2 situated in line i and column j, i.e. identified by the identification code IDij, stores the reduced addressing code Cij in its register 13. Then the control circuit 3 transmits two other signals, for example Idij+1 and Cij+1, enabling the reduced addressing code Cij+1 to be stored in the register of the microsystem 2 situated in line i and the next column j+1. In this way, each microsystem receives its corresponding reduced addressing code C.

The reduced addressing codes C are preferably chosen as simple and short as possible, for example according to the position of the associated microsystem 2 in the array 1. For example, as represented in FIG. 1, the total number of microsystems 2 being nine, the reduced addressing codes C can correspond to increasing numbers, from 0 to 8, from a first microsystem 2 associated to the reduced addressing code C=0 up to the last microsystem 2 associated to the reduced addressing code C=8, so as to perform linear, sequential and incremental addressing of the microsystems 2.

In a random addressing mode, reduced addressing codes C can be associated to microsystems 2 situated in a random position in the array.

In the case where the reduced codes correspond to increasing numbers, each subsequent addressing phase of the microsystems 2 comprises transmission, by the control circuit 3, of a reset signal RAZ, and transmission, by the control circuit 3, of successive increment signals S1. These signals are received by all the microsystems 2. As illustrated in FIG. 5, each microsystem 2 monitors resetting of its counter 14, in a step F2, on receipt of a reset signal RAZ (YES output of F1) and then compares the content Sc of its counter 14 with the content C of its register 13, in a step F3, so as to trigger execution of a pre-determined command, in a step F4, when these contents Sc and C are identical (YES output of F3). After the step F4 or when the content Sc of the counter 14 is different from the content C of the register 13 (NO output of F3), each microsystem 2 monitors incrementation of the content of its counter 14, in a step F6, upon receipt of an increment signal S1 (YES output of F5). The interval between two increment signals S1 is sufficiently long to enable the corresponding command to be executed. After the counter has been incremented, the microsystem checks, in the step F7, whether it has received a reset signal RAZ before looping back to the input of step F3 if this is not the case (NO output of F7) or to the input of step F2 if this is the case (YES output of F7).

With reference to FIG. 1, the microsystem 2 corresponding to the reduced addressing code C=0 thus executes its command as soon as a reset signal RAZ is received, the content (Sc=0) of its counter 14 then being identical to the content (C=0) of its register 13. Then, after a first increment signal S1, the content (Sc=1) of the counter of the microsystem 2 corresponding to the reduced addressing code C=1 is identical to the content of its register 13 and only this microsystem executes its command. The microsystems 2 thus successively execute their commands after they have received the number of increment signals S1 corresponding to their reduced addressing code. Successive selective addressing of the set of microsystems is thus controlled by the control circuit 3 by means of the increment signals S1. The advantage of this addressing method consists in the simplicity of the increment signals compared with the complexity of the initial identification codes ID, the length whereof is conventionally comprised between 32 and 128 bits, which requires a long transmission time and limits the number of individual addressing operations per time unit.

In the particular embodiment represented in FIG. 3, the microsystems 2 are arranged in lines and columns and the reduced addressing code C comprises a line number i and a column number j, respectively from 0 to 2 in FIG. 3, respectively stored in a line register 13 and in a column register 13 during the initialization phase. During the addressing phase, the contents of the line and column registers 13 are respectively compared with the contents of a line counter 14 and a column counter 14. The control circuit 3 then successively transmits line increment signals S1 and column increment signals S2 to all the microsystems 2. Whereas the line increment signals S1 only cause the line counters of all the microsystems 2 to be incremented, the column increment signals S2 not only cause the column counters to be incremented but also cause the line counters to be reset, as represented in FIG. 4. Thus, addressing of the microsystems 2 arranged in a first column can be performed by a succession of line increment signals S1. Then a column increment signal S2 causing the line counters to be reset and the column counters to be incremented enables a second column of microsystems 2 to be addressed by a new succession of line increment signals S1. It is obvious that the role of the lines and columns can be inverted.

The microsystems 2 can also be arranged in a three-dimensional array, that is to say in lines, in columns and depending on the height. In a particular embodiment, the reduced addressing code C then comprises an additional number associated to the height and stored in an additional register 13 associated to the height. Each microsystem comprises an additional counter 14 associated to the height, the content of the register 13 associated to the height then being compared with the content of the additional counter 14 associated to the height. As represented in FIG. 4, the control circuit 3 then preferably transmits height increment signals S3 causing the line and column counters 14 to be reset and the additional height counters to be incremented. Thus, by using the set of instructions represented in FIG. 4, addressing of the microsystems 2 can be performed column by column, as described previously, and, in addition, after all the microsystems 2 of a given height have been addressed, for different heights by incrementing the height by means of a signal S3. In this case as well, the role of the lines, columns and heights can be inverted.

In a particular embodiment, the microsystem 2 transmits an acquit signal after executing its command (step F4), causing the next increment signal S1, S2, or S3 to be transmitted by the control circuit 3. This is in particular desirable in the case where the times required for execution of the commands of the microsystems 2 are variable.

The microsystems are designed to execute a set of commands such as read, write, movement or system configuration. The latter may comprise description of the action the microsystem will have to execute. By this, another command triggering execution will have to be transmitted in due course.

In the case where the microsystems 2 are designed to each perform a single type of command, transmission by the control circuit 3 of data representative of the type of command to be executed by the microsystems 2 can be associated to transmission of a reset signal RAZ. In the case where the command of each microsystem 2 is individually controlled by the control circuit, transmission of the data representative of the type of command to be executed by the microsystems can be associated to transmission of an increment signal S1, S2 or S3. The different commands to be executed by a microsystem can be transmission of a signal Sm representative of a measurement made by a sensor of the microsystem, actuation of an actuator integrated in the microsystem 2, activation of a display element, etc. It is also possible for transmission of data representative of the type of command to be executed by each microsystem 2 to be performed in an additional configuration phase, before the addressing phase, which enables the duration of transmissions of the signals during the addressing phase to be reduced and thus enables the addressing speed to be increased.

The invention is not limited to the embodiments represented. In particular, the antennas 8 can have any geometry, for example circular, linear or square, depending, among other things, on the frequencies used.

Moreover, commands simultaneously performed by all the microsystems 2 can be envisaged.

1-17. (canceled)

18. Method of addressing a plurality of microsystems which can be individually addressed by a control circuit, the control circuit and each microsystem comprising electromagnetic transmission means, each microsystem comprising a counter and having an addressing code, an addressing phase of the microsystems comprising transmission, by the control circuit, of successive increment signals, each microsystem monitoring resetting of its counter and, upon receipt of an increment signal, incrementation of the content of its counter, and each microsystem comparing the content of its counter and its addressing code, so as to trigger execution of a pre-determined command when the content of its counter and its addressing code are identical, method wherein, the microsystems forming an array of microsystems, each microsystem comprises an identification code, in a read-only memory, and the method comprises an initialization phase successively comprising, for each microsystem, addressing, by the control circuit, of the microsystem by its identification code and storing of a reduced addressing code supplied by the control circuit in a register of the microsystem.

19. Method of addressing according to claim 18, wherein the reduced addressing code of a microsystem is a function of its position in the array.

20. Method of addressing according to claim 18, wherein the reduced addressing codes of the microsystems correspond to increasing numbers starting from a first microsystem.

21. Method of addressing according to claim 18, wherein the microsystems are arranged in lines and columns, the reduced addressing code of each microsystem comprising a line number and a column number respectively stored in line and column registers of the microsystem, the contents of the line and column registers being respectively compared with the contents of the line and column counters of the microsystem.

22. Method of addressing according to claim 21, wherein the control circuit successively transmits line increment signals and column increment signals, the line increment signals causing the content of the line counters to be incremented and the column increment signals causing the content of the column counters to be incremented and the line counters of all the microsystems to be reset.

23. Method of addressing according to claim 22, wherein the microsystems are arranged in lines, in columns and according to height, the reduced addressing code comprising an additional number associated to the height, stored in an additional register associated to the height, each microsystem comprising an additional counter associated to the height, the content of the register associated to the height being compared with the content of the counter associated to the height.

24. Method of addressing according to claim 23, wherein the control circuit transmits height increment signals causing the additional counters associated to the height to be incremented and the line and column counters of all the microsystems to be reset.

25. Method of addressing according to claim 18, wherein a microsystem transmits an acquit signal after the latter has executed its command.

26. Method of addressing according to claim 18, wherein the control circuit transmits data representative of the type of command to be executed by the microsystems in association with transmission of a reset signal.

27. Method of addressing according to claim 18, wherein the control circuit transmits data representative of the type of command to be executed by the microsystems in association with transmission of an increment signal.
